(19) United States
(12) Patent Application Publication
(10) Pub. No.: US 2014/0306961 A1
(43) Pub. Date: Oct. 16, 2014

(54) MEDICAL IMAGE PROCESSING SYSTEM, RECORDING MEDIUM HAVING RECORDED THEREON A MEDICAL IMAGE PROCESSING PROGRAM AND MEDICAL IMAGE PROCESSING METHOD

(71) Applicant: ZIOSOFT, INC., Tokyo (JP)

(72) Inventor: Tsuyoshi NAGATA, Minato-ku (JP)

(73) Assignee: ZIOSOFT, INC., Tokyo (JP)

(21) Appl. No.: 14/250,992

(22) Filed: Apr. 11, 2014

(30) Foreign Application Priority Data
Apr. 11, 2013 (JP) 2013-083421

(51) Int. Cl. G06T 15/08

(52) U.S. Cl. CPC G06T 15/08
USPC 345/424

(57) ABSTRACT

An image processing system of the present invention is an image processing system using volume data, and includes a recording unit that records a plurality of volume data indicating a subject which has a tubular structure; a tubular structure association unit that associates the tubular structures included in the respective plurality of volume data with each other; an attention point designation unit that designates an attention point on the tubular structure with respect to at least one of the plurality of volume data; a corresponding point creation unit that creates a corresponding point corresponding to the attention point in accordance with the association, with respect to each of the tubular structures included in the respective plurality of volume data; a multi planar reconstruction image generation unit that generates a plurality of multi planar reconstruction images including the attention point or the corresponding point from the plurality of volume data; and a display unit that consecutively displays the plurality of multi planar reconstruction images in a state where the attention point or the corresponding point is displayed.

### BACKGROUND OF THE INVENTION

1. Field of the Invention

The present invention relates to a medical image processing system and a medical image processing program. In particular, the present invention relates to a medical image processing system and a medical image processing program which are capable of consecutively displaying three-dimensional images in time series.

2. Background Art

Hitherto, along with the spread of a multi-slice CT scanner, a variety of three-dimensional image processing techniques have been suggested. In addition to observing cut slices from volume data which is a three-dimensional image, the techniques include, for example, a technique such as multi planar reconstruction (MPR) or curved multi planar reconstruction (CPR). Specifically, there is a known image processing apparatus that acquires a path along a tubular structure, visualizes and displays volume data along a predetermined range of the path, sets positions on a screen for specifying positions on the path in which crossing cross-section information indicating two or more crossing cross-sections perpendicular to the path is to be acquired, acquires the crossing cross-section information indicating the crossing cross-sections of the positions on the path which correspond to the set positions on the screen, displays the crossing cross-sections on the screen on the basis of the crossing cross-section information, newly designates a predetermined range of the path to be displayed on the screen, visualizes volume data along the predetermined range of the newly-designated path and displays the volume data on the screen, newly acquires the crossing cross-section information indicating the crossing cross-sections of the positions on the path which correspond to the set positions on the screen, and displays the crossing cross-sections on the screen on the basis of the crossing cross-section information (for example, see Japanese Unexamined Patent Application Publication No. 2007-68658). According to the image processing apparatus disclosed in Japanese Unexamined Patent Application Publication No. 2007-68658, it is possible to acquire three-dimensional volume data from an imaging modality and to smoothly display a predetermined range of a path along a tubular structure such as a straight CPR from a starting point of a blood vessel to be extracted, in association with a crossing cross-section of an MPR image or the like which crosses the path.

### SUMMARY OF THE INVENTION

In so-called cine-reproduction in which an area such as a heart from volume data imaged by a CT scanner or the like is four-dimensionally displayed as a moving picture, a reader can observe the area. However, there is a problem in that it is not possible to easily observe the area because an object to be observed moves. In particular, in a multi planar reconstruction image, target to be observed must not jump off the plane.

Consequently, the present invention provides a medical image processing system, a recording medium having recorded thereon a medical image processing program and a medical image processing method which are capable of allowing a diagnosis to be performed without an observation area of a subject being lost from sight at the time of four-dimensionally displaying a moving picture.

A medical image processing system using volume data includes a recording unit that records a plurality of volume data indicating a subject which has a tubular structure; a tubular structure association unit that associates the tubular structures included in the respective plurality of volume data with each other; an attention point designation unit that designates an attention point on the tubular structure with respect to at least one of the plurality of volume data; a corresponding point creation unit that creates a corresponding point corresponding to the attention point in accordance with the association, with respect to each of the tubular structures included in the respective plurality of volume data; a multi planar reconstruction image generation unit that generates a plurality of multi planar reconstruction images including the attention point or the corresponding point from the plurality of volume data; and a display unit that consecutively displays the plurality of multi planar reconstruction images in a state where the attention point or the corresponding point is displayed.

The display unit consecutively may display the attention points or the corresponding points within a certain range on the same view.

The multi planar reconstruction image may be a curved multi planar reconstruction image along a path of the tubular structure.

A cross-section of the multi planar reconstruction image may be a plane in which a direction of the tubular structure at the attention point or the corresponding point may be set to a normal line.

The multi planar reconstruction image generation unit may generate a curved multi planar reconstruction image constituted by a curved surface along the path of the tubular structure and a multi planar reconstruction image by a flat plane in which a direction of the tubular structure at the attention point or the corresponding point is set to a normal line, and the display unit consecutively may display the plurality of plane section reconstruction images in synchronization with the consecutive display of the plurality of curved multi planar reconstruction images.

The tubular structure association unit may perform correction on each of the tubular structures included in the respective plurality of volume data so that the distortion of the path of the tubular structure is minimized.

The corresponding point creation unit may further create scaling information of the tubular structure at the corresponding point, and the display unit may further expand and contract the plurality of multi planar reconstruction images by using the scaling information and displays the images.

An area of the subject may be a heart, and the tubular structure may be a coronary artery.

A recording medium of the present invention having recorded thereon a medical image processing program using volume data is a program causing a computer to realize a function of recording a plurality of volume data indicating a subject which has a tubular structure; a function of associating the tubular structures included in the respective plurality of volume data with each other; a function of designating an attention point on the tubular structure with respect to at least one of the plurality of volume data; a function of creating a corresponding point corresponding to the attention point in accordance with the association, with respect to each of the tubular structures included in the respective plurality of volume data; a function of generating a plurality of multi planar reconstruction images including the attention point or the corresponding point from the plurality of volume data; and a function of consecutively displaying the plurality of multi planar reconstruction images in a state where the attention point or the corresponding point is displayed.

A medical image processing method using volume data of the present invention is a medical image processing method using volume data, and includes recording a plurality of volume data indicating a subject which has a tubular structure; associating the tubular structures included in the respective plurality of volume data with each other; designating an attention point on the tubular structure with respect to at least one of the plurality of volume data; creating a corresponding point corresponding to the attention point in accordance with the association, with respect to each of the tubular structures included in the respective plurality of volume data; generating a plurality of multi planar reconstruction images including the attention point or the corresponding point from the plurality of volume data; and consecutively displaying the plurality of multi planar reconstruction images in a state where the attention point or the corresponding point is displayed.

The displaying of the plurality of multi planar reconstruction images may include consecutively displaying the attention points or the corresponding points within a certain range on the same view.

The multi planar reconstruction image may be a curved multi planar reconstruction image along a path of the tubular structure.

A cross-section of the multi planar reconstruction image may be a plane in which a direction of the tubular structure at the attention point or the corresponding point is set to a normal line.

The generating of a plurality of multi planar reconstruction images may include generating a curved multi planar reconstruction image constituted by a curved surface along the path of the tubular structure and a multi planar reconstruction image by a flat plane in which a direction of the tubular structure at the attention point or the corresponding point is set to a normal line, and the displaying of the plurality of multi planar reconstruction images may include consecutively displaying the plurality of plane section reconstruction images in synchronization with the consecutive display of the plurality of curved multi planar reconstruction images.

The associating of the tubular structures may include performing correction on each of the tubular structures included in the respective plurality of volume data so that the distortion of the path of the tubular structure is minimized.

The creating of a corresponding point may include further creating scaling information of the tubular structure at the corresponding point. The displaying of the plurality of multi planar reconstruction images may include further expanding and contracting the plurality of multi planar reconstruction images by using the scaling information and displays the images.

An area of the subject may be a heart, and the tubular structure may be a coronary artery.

According to the medical image processing system, the recording medium having recorded thereon the medical image processing program and the medical image processing method, at the time of four-dimensionally displaying a moving picture, the presence of a cross-section on an observation area is secured and the observation area stays within a certain range on a screen, and thus it is possible to perform a diagnosis without losing sight of an observation area of a subject. In addition, at the time of four-dimensionally displaying a moving picture, it is possible to intensively diagnose changes in the shape of the observation area of the subject.

### BRIEF DESCRIPTION OF THE DRAWINGS

FIG. 1 is a block diagram showing an example of a medical image processing system of the present invention.

FIG. 2 is a flow chart showing an example of a flow of the medical image processing system of the present invention.

FIG. 3 is a flow chart showing an example of a flow of the medical image processing system of the present invention.

FIG. 4 is a flow chart showing an example of a flow of the medical image processing system of the present invention.

FIG. 5 is a schematic diagram showing an example of a subject of the present invention.

FIG. 6 is a schematic diagram showing volume data and MPR of a subject.

FIG. 7 is a schematic diagram showing CPR of a subject.

FIG. 8 is a diagram showing distortion of a path in CPR.

FIG. 9 is a schematic diagram showing straight CPR and MPR of a subject.

### DETAILED DESCRIPTION OF THE INVENTION

An embodiment of a medical image processing system of the present invention will be described below with reference to the accompanying drawings.

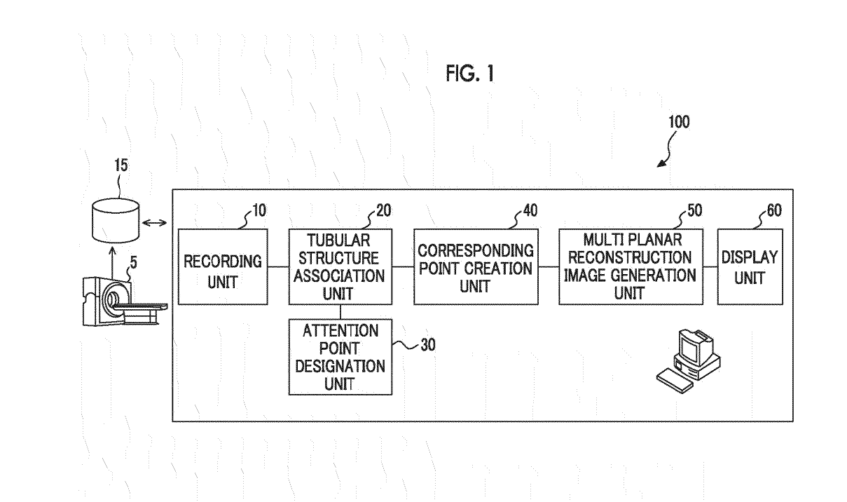

FIG. 1 is a block diagram showing an example of a medical image processing system of the present invention.

As shown in FIG. 1, an image processing system 100 of the present invention includes a recording unit 10, a tubular structure association unit 20, an attention point designation unit 30, a corresponding point creation unit 40, a multi planar reconstruction image generation unit 50, and a display unit 60.

The recording unit 10 records a plurality of volume data indicating a subject which has a tubular structure. Cross-sections of the subject are consecutively imaged by, for example, a CT scanner 5, and one piece of volume data can be generated from these multi planar images. Further, the imaging is repeatedly performed, and thus it is possible to generate a plurality of volume data that are sequentially arranged in time series. These volume data are recorded in the recording unit 10 through a server 15.

The tubular structure association unit 20 associates the tubular structures that are included in the respective plurality of volume data with each other. Known image registration technique may be used. Specifically, it is possible to acquire relevant information by associating coordinates of the tubular structures included in the respective volume data with each other and to perform positioning of the relevant information (for example, see Japanese Unexamined Patent Application Publication No. 2011-110282).

The attention point designation unit 30 designates an attention point on the tubular structure with respect to at least one of the plurality of volume data. The designation is performed using, for example, a keyboard or a mouse. The designation may be performed directly by a user or by a system. In addition, the designation may be implicitly and indirectly performed. For example, an area which is displayed at the upper end of a designation result screen to be the attention point.

The corresponding point creation unit 40 creates a corresponding point corresponding to the attention point in accordance with the association, with respect to each of the tubular structures included in the respective plurality of volume data.

The multi planar reconstruction image generation unit 50 generates a plurality of multi planar reconstruction images including the attention point or the corresponding point from the plurality of volume data. The multi planar reconstruction image includes a curved multi planar reconstruction image and a multi planar reconstruction image of a flat plane.

The display unit 60 consecutively displays the plurality of multi planar reconstruction images in a state where the attention point or the corresponding point is displayed. A display device or the like can be used as the display unit 60.

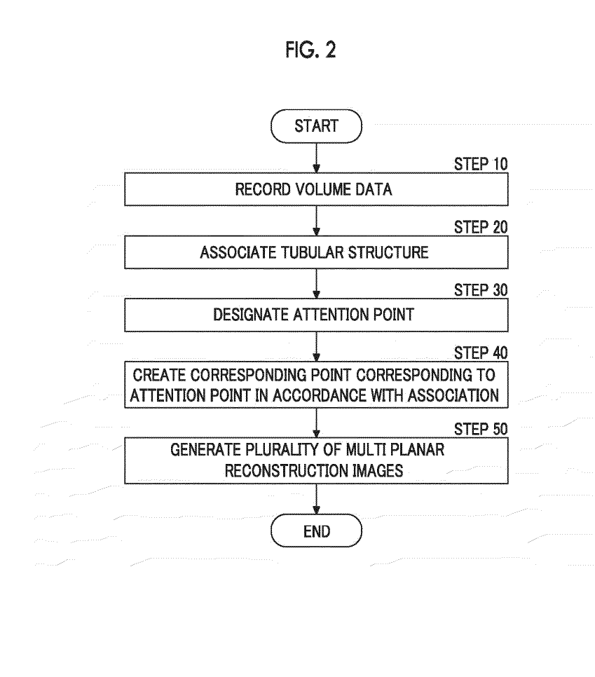

FIG. 2 is a flow chart showing an example of a flow of the medical image processing system of the present invention.

As shown in FIG. 2, in the image processing system of the present invention, first, the recording unit 10 records a plurality of volume data of a subject (STEP 10).

Subsequently, the tubular structure association unit performs the registration process and associates structures included in the plurality of volume data with each other (STEP 20).

Next, the attention point designation unit 30 designates an attention point on a tubular structure (STEP 30).

Subsequently, the corresponding point creation unit creates a corresponding point corresponding to the attention point in accordance with the association, with respect to volume data other than the above-described volume data (STEP 40).

Finally, the multi planar reconstruction image generation unit 50 generates a plurality of multi planar reconstruction images including a cross-section of the attention point or a cross-section of the corresponding point from the plurality of volume data (STEP 50).

It is preferable that the attention points or the corresponding points be consecutively displayed within a certain range on the same view in the display unit 60. When an object to be observed is zoomed and the details thereof are observed, the movement of an observation area makes the observation difficult. For this reason, the above-described configuration is provided, and thus it may prevent losing sight of the observation area.

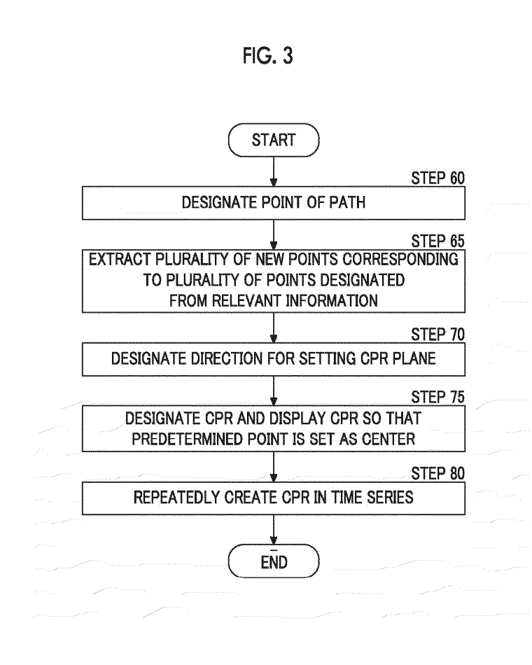

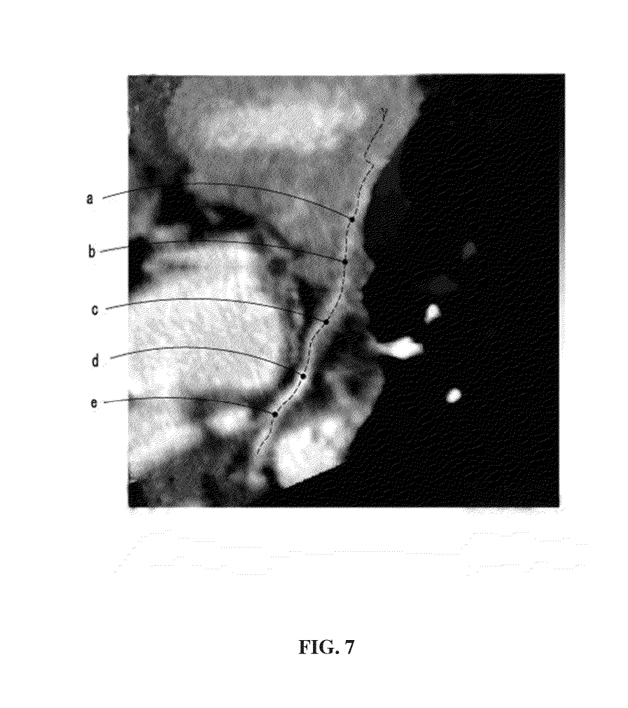

A multi planar reconstruction image generated by the multi planar reconstruction image generation unit 50 can be set to a curved multi planar reconstruction image (CPR) which is constituted by a curved surface along the path of the tubular structure. FIG. 3 is a flow chart showing an example of a flow for forming the CPR, and FIG. 7 is a diagram showing CPR.

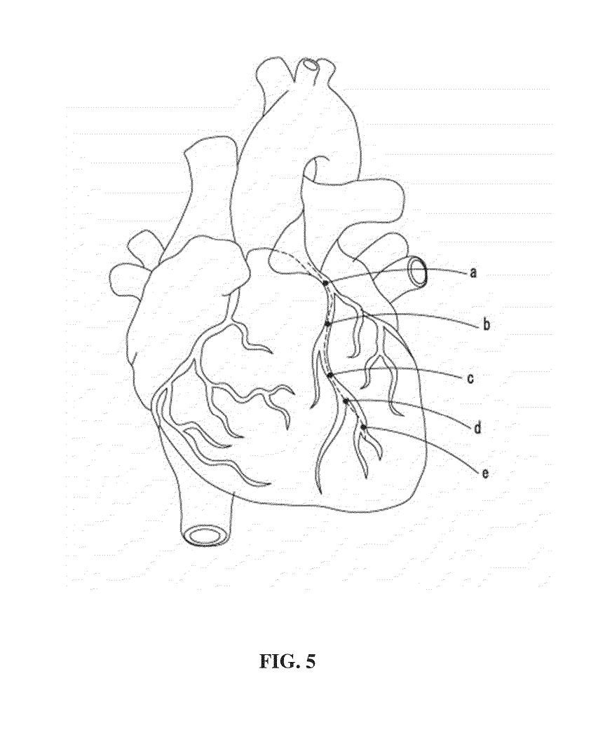

FIG. 5 is a schematic diagram showing a heart which is an example of an area of a subject, and shows a case where a tubular structure is a coronary artery. As shown in FIG. 5, a path (pₜ) passing through points “a” to “e” is acquired in volume data as a tubular structure. Any known path tracking algorithm (for example, see Japanese Unexamined Patent Application Publication No. 2004-358001) may be used to acquire the tubular structure, or a user may acquire the tubular structure by manually designating a path. Meanwhile, in this embodiment, the tubular structure is represented by using a path, but may be represented using any means. For example, the tubular structure may be represented by an explicit region or may be represented by implicit level set.

In this embodiment, first, a point (vₜ) on a path is designated as an attention point, as shown in FIG. 3 (STEP 60).

Subsequently, points (v₀ to vₙ) on paths (p₀ to pₙ) of volume data corresponding to the point (vₜ) are acquired using relevant information (STEP 65). Meanwhile, an attention point and a corresponding point on the tubular structure are sufficient as long as these points have a certain relationship with the tubular structure, and are not required to be strictly on the path.

Next, a direction for setting a CPR plane is designated (STEP 70). Specifically, a direction d for defining the CPR plane is designated by a user. Meanwhile, an object to be plotted is likely to be ascertained when the directions d are set to be the same as each other in all the volume data. However, in a case where the tubular structure is arranged in a twisted manner, the object to be plotted is likely to be ascertained when the directions are different from each other in the respective volume data.

Subsequently, the CPR plane is specified, and the CPR is displayed so that a predetermined point is set to the center as shown in FIG. 7 (STEP 75). Specifically, the CPR plane is specified by (pᵢ, d), and plotting is performed so that vᵢ is set to the center of a window.

Finally, the CPR is repeatedly created in time series (STEP 80).

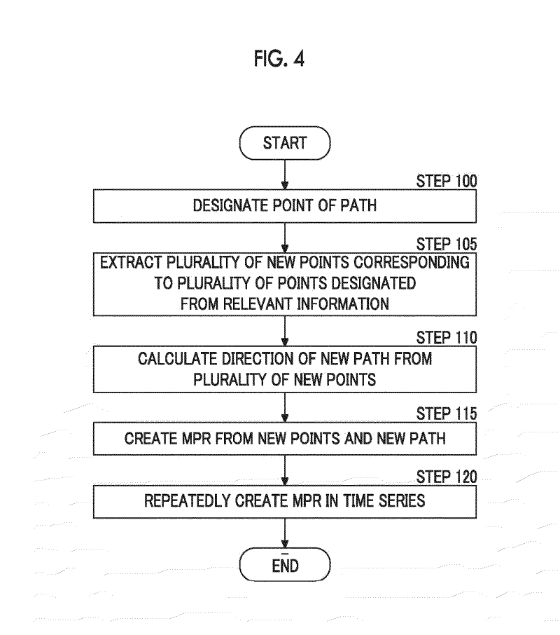

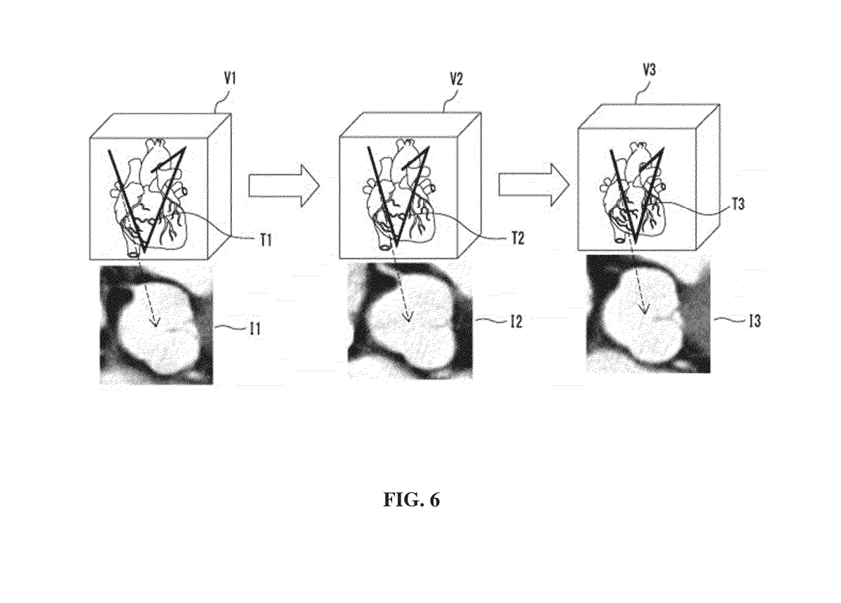

A cross-section of the curved multi planar reconstruction image can be achieved as a cross-section of the tubular structure at the attention point or the corresponding point with its normal of the attention point or the corresponding point. FIG. 4 is a flow chart showing an example of a flow for forming the flat multi planar reconstruction image of the cross-section, and FIG. 6 is a diagram showing the flat multi planar reconstruction image.

In this embodiment, first, a point (vₜ) on a path is designated as shown in FIGS. 4 and 6(STEP 100).

Subsequently, points (v₀ to vₙ) on paths (p₀ to pₙ) of volume data corresponding to the point (vₜ) are acquired using relevant information (STEP 105).

Next, a direction for setting a cross-section is designated (STEP 110). Specifically, directions (d₀ to dₙ) of the paths (p₀ to pₙ) at the points (v₀ to vₙ) are acquired.

Subsequently, the cross-section is specified, and the flat multi planar reconstruction image (Iₙ in FIG. 6) is displayed so that a predetermined point is set to the center as shown in FIG. 6 (STEP 115). Specifically, the cross-section is specified by (vᵢ,dᵢ), and plotting is performed so that vᵢ is set to the center of a window.

Finally, the flat multi planar reconstruction image is repeatedly created in time series (STEP 120). Meanwhile, the designation of three points on the volume data specifies a plane, and thus it is also possible to create the MPR without forming a path.

It is preferable that the multi planar reconstruction image generation unit 50 generate a curved multi planar reconstruction image constituted by a curved surface along a path of a tubular structure and a flat multi planar reconstruction image constituted by a cross-section in which a direction of the tubular structure at an attention point or a corresponding point is set to a normal line and that the display unit 60 consecutively display the plurality of flat multi planar reconstruction images in synchronization with the consecutive display of the plurality of curved multi planar reconstruction images.

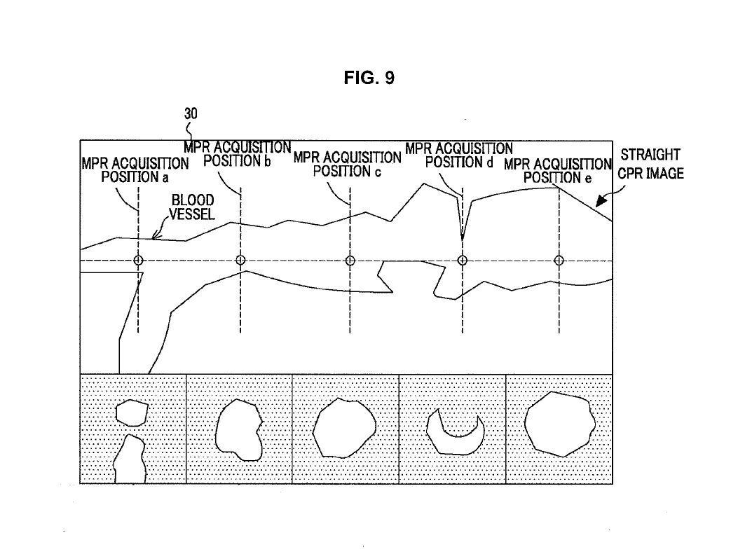

FIG. 9 is a schematic diagram showing a screen on which both curved multi planar reconstruction image and flat multi planar reconstruction image are displayed in the display unit 60, and shows the screen on which flat multi planar reconstruction image acquisition positions on a straighten curved multi planar reconstruction image and the flat multi planar reconstruction images thereof are displayed. Meanwhile, the straighten curved multi planar reconstruction image means that a curved surface of the CPR is distorted (or stretched) so that a path is plotted as a straight line.

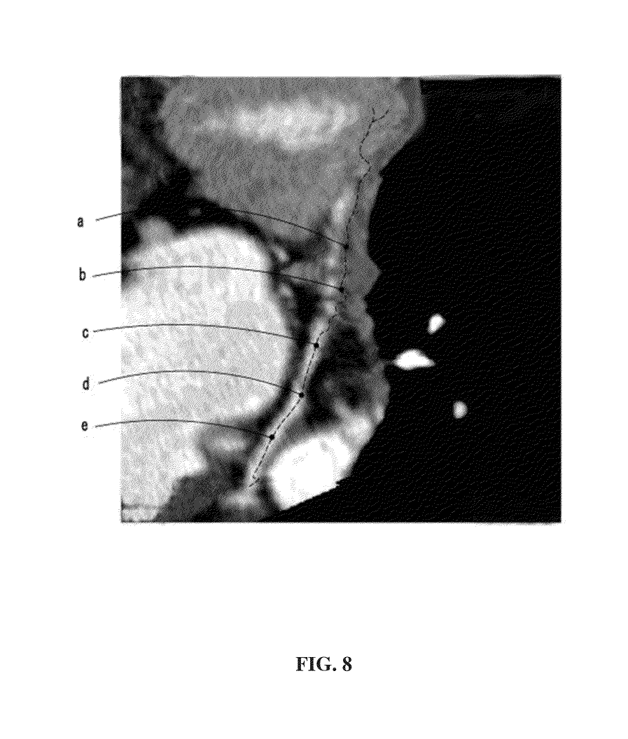

In addition, it is preferable that the tubular structure association unit 20 perform correction on each of tubular structures included in the respective plurality of volume data so that the distortion of a path of the tubular structure is minimized. FIG. 8 shows the distortion in CPR, as an example.

It is preferable that the corresponding point creation unit 40 further create scaling information of a tubular structure at a corresponding point and that the display unit 60 further zoom a plurality of multi planar reconstruction images by using the scaling information.

A recording medium of the present invention having recorded thereon a medical image processing program using volume data is a program causing a computer to realize a function of recording a plurality of volume data indicating a subject which has a tubular structure; a function of associating the tubular structures included in the respective plurality of volume data with each other; a function of designating an attention point on the tubular structure with respect to at least one of the plurality of volume data; a function of creating a corresponding point corresponding to the attention point in accordance with the association, with respect to each of the tubular structures included in the respective plurality of volume data; a function of generating a plurality of multi planar reconstruction images including the attention point or the corresponding point from the plurality of volume data; and a function of consecutively displaying the plurality of multi planar reconstruction images in a state where the attention point or the corresponding point is displayed.

A medical image processing method of the present invention is a medical image processing method using volume data which includes associating the tubular structures included in the respective plurality of volume data with each other, designating an attention point on the tubular structure with respect to at least one of the plurality of volume data, creating a corresponding point corresponding to the attention point in accordance with the association, with respect to each of the tubular structures included in the respective plurality of volume data, creating a plurality of multi planar reconstruction images including the attention point or the corresponding point from the plurality of volume data, and consecutively displaying a plurality of multi planar images in a state where the attention point or the corresponding point is displayed. The details thereof are similar to those of the above-described medical image processing system.

Although the embodiment of the present invention has been described so far, the present invention is not limited to the configuration described in the above embodiment.

What is claimed is:

1. A medical image processing system using volume data, the system comprising:
a recording unit that records a plurality of volume data indicating a subject which has a tubular structure;
a tubular structure association unit that associates the tubular structures included in the respective plurality of volume data with each other;
an attention point designation unit that designates an attention point on the tubular structure with respect to at least one of the plurality of volume data;
a corresponding point creation unit that creates a corresponding point corresponding to the attention point in accordance with the association, with respect to each of the tubular structures included in the respective plurality of volume data;
a multi planar reconstruction image generation unit that generates a plurality of multi planar reconstruction images including the attention point or the corresponding point from the plurality of volume data; and
a display unit that consecutively displays the plurality of multi planar reconstruction images in a state where the attention point or the corresponding point is displayed.

2. The medical image processing system according to claim 1, wherein the display unit consecutively displays the attention points or the corresponding points within a certain range on the same view.

3. The medical image processing system according to claim 1, wherein the multi planar reconstruction image is a curved multi planar reconstruction image along a path of the tubular structure.

4. The medical image processing system according to claim 1, wherein a cross-section of the multi planar reconstruction image is a plane in which a direction of the tubular structure at the attention point or the corresponding point is set to a normal line.

5. The medical image processing system according to claim 1, wherein the multi planar reconstruction image generation unit generates a curved multi planar reconstruction image constituted by a curved surface along the path of the tubular structure and a multi planar reconstruction image by a flat plane in which a direction of the tubular structure at the attention point or the corresponding point is set to a normal line, and the display unit consecutively displays the plurality of plane section reconstruction images in synchronization with the consecutive display of the plurality of curved multi planar reconstruction images.

6. The medical image processing system according to claim 1, wherein the tubular structure association unit performs correction on each of the tubular structures included in the respective plurality of volume data so that the distortion of the path of the tubular structure is minimized.

7. The medical image processing system according to claim 1,
wherein the corresponding point creation unit further creates scaling information of the tubular structure at the corresponding point, and
wherein the display unit further expands and contracts the plurality of multi planar reconstruction images by using the scaling information and displays the images.

8. The medical image processing system according to claim 1, wherein an area of the subject is a heart, and the tubular structure is a coronary artery.

9. A recording medium having recorded thereon a medical image processing program using volume data, the program causing a computer to realize:
a function of recording a plurality of volume data indicating a subject which has a tubular structure;
a function of associating the tubular structures included in the respective plurality of volume data with each other;
a function of designating an attention point on the tubular structure with respect to at least one of the plurality of volume data;
a function of creating a corresponding point corresponding to the attention point in accordance with the association, with respect to each of the tubular structures included in the respective plurality of volume data;
a function of generating a plurality of multi planar reconstruction images including the attention point or the corresponding point from the plurality of volume data; and
a function of consecutively displaying the plurality of multi planar reconstruction images in a state where the attention point or the corresponding point is displayed.

10. A medical image processing method using volume data comprising:
recording a plurality of volume data indicating a subject which has a tubular structure;
associating the tubular structures included in the respective plurality of volume data with each other;
designating an attention point on the tubular structure with respect to at least one of the plurality of volume data;
creating a corresponding point corresponding to the attention point in accordance with the association, with respect to each of the tubular structures included in the respective plurality of volume data;
generating a plurality of multi planar reconstruction images including the attention point or the corresponding point from the plurality of volume data; and
consecutively displaying the plurality of multi planar reconstruction images in a state where the attention point or the corresponding point is displayed.

11. The medical image processing method according to claim 10, wherein the displaying of the plurality of multi planar reconstruction images includes consecutively displaying the attention points or the corresponding points within a certain range on the same view.

12. The medical image processing method according to claim 10, wherein the multi planar reconstruction image is a curved multi planar reconstruction image along a path of the tubular structure.

13. The medical image processing method according to claim 10, wherein a cross-section of the multi planar reconstruction image is a plane in which a direction of the tubular structure at the attention point or the corresponding point is set to a normal line.

14. The medical image processing method according to claim 10, wherein the generating of a plurality of multi planar reconstruction images includes generating a curved multi planar reconstruction image constituted by a curved surface along the path of the tubular structure and a multi planar reconstruction image by a flat plane in which a direction of the tubular structure at the attention point or the corresponding point is set to a normal line, and the displaying of the plurality of multi planar reconstruction images includes consecutively displaying the plurality of plane section reconstruction images in synchronization with the consecutive display of the plurality of curved multi planar reconstruction images.

15. The medical image processing method according to claim 10, wherein the associating of the tubular structures includes performing correction on each of the tubular structures included in the respective plurality of volume data so that the distortion of the path of the tubular structure is minimized.

16. The medical image processing method according to claim 10,
wherein the creating of a corresponding point includes further creating scaling information of the tubular structure at the corresponding point, and
wherein the displaying of the plurality of multi planar reconstruction images includes further expanding and contracting the plurality of multi planar reconstruction images by using the scaling information and displays the images.

17. The medical image processing method according to claim 10, wherein an area of the subject is a heart, and the tubular structure is a coronary artery.
